(19) United States
(12) Patent Application Publication
(10) Pub. No.: US 2024/0040130 A1
(43) Pub. Date: Feb. 1, 2024

(54) COMPRESSSED PICTURE-IN-PICTURE SIGNALING

(71) Applicant: Telefonaktiebolaget LM Ericsson (publ), Stockholm (SE)

(72) Inventors: Rickard SJÖBERG, STOCKHOLM (SE); Martin PETTERSSON, Vallentuna (SE); Mitra DAMGHANIAN, Upplands-Bro (SE)

(73) Assignee: Telefonaktiebolaget LM Ericsson (publ), Stockholm (SE)

(21) Appl. No.: 17/919,974

(22) PCT Filed: Mar. 24, 2021
(86) PCT No.: PCT/SE2021/050257

§ 371 Date: Oct. 19, 2022

Related U.S. Application Data
(60) Provisional application No. 63/013,923, filed on Apr. 22, 2020.

(51) Int. Cl. H04N 19/167; H04N 19/70; H04N 19/172; H04N 19/30

(52) U.S. Cl. CPC H04N 19/167; H04N 19/70; H04N 19/172; H04N 19/30

(57) ABSTRACT

There is provided a method for decoding a position and a size for a subpicture, SP, in a picture from a bitstream. The method comprises decoding a coding tree unit, CTU, size from a first syntax element, S1, in the bitstream. The method comprises obtaining a scale factor value, F, wherein F is larger than (1). The method further comprises deriving a scaled position value for the subpicture SP, wherein deriving the scaled position value comprises: i) obtaining a position value based on information in the bitstream and ii) setting the scaled position value equal to the product of the position value and F. The method comprises deriving a size of the subpicture based on the scaled position value.

### TECHNICAL FIELD

Disclosed are embodiments related to picture-in-picture signaling.

### BACKGROUND

### 1. HEVC and VVC

High Efficiency Video Coding (HEVC) is a block-based video codec standardized by ITU-T and MPEG that utilizes both temporal and spatial prediction. Spatial prediction is achieved using intra (I) prediction from within the current picture. Temporal prediction is achieved using uni-directional (P) or bi-directional inter (B) prediction on block level from previously decoded reference pictures. In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization and inverse transformation to obtain the residual, and then adds the residual to an intra or inter prediction to reconstruct a picture.

MPEG and ITU-T is working on the successor to HEVC within the Joint Video Exploratory Team (JVET). The name of this video codec under development is Versatile Video Coding (VVC). The current version of the VVC draft specification at the time of writing this text is JVET-Q2001-vD.

### 2. Components

A video (a.k.a., video sequence) consists of a series of pictures (a.k.a., images) where each picture consists of one or more components. Each component can be described as a two-dimensional rectangular array of sample values. It is common that a picture in a video sequence consists of three components; one luma component Y where the sample values are luma values and two chroma components Cb and Cr, where the sample values are chroma values. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as color components.

### 3.Blocks and Units

A block is one two-dimensional array of samples. In video coding, each component is split into blocks and the coded video bitstream consists of a series of coded blocks. It is common in video coding that the image is split into units that cover a specific area of the image. Each unit consists of all blocks from all components that make up that specific area and each block belongs fully to one unit. The macroblock in H.264 and the Coding unit (CU) in HEVC are examples of units.

In VVC, a picture is partitioned into coding tree units (CTUs), and a coded picture in a bitstream consists of a series of coded CTUs such that all CTUs in the picture are coded. The scan order of CTUs depend on how the picture is partitioned by higher level partition tools such as slices and tiles, described below. A VVC CTU consists of one luma block and optionally (but usually) two spatially co-located chroma blocks. The size of the luma block of the CTU is square and the size is configurable and conveyed by syntax elements in the bitstream. When a decoder is decoding the bitstream, the decoder decodes the syntax elements to derive the size of the luma block of the CTU size to use for decoding. This size is usually referred to as the CTU size.

### 4. Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g. data for multiple layers in the bitstream.

### 5. Decoding Capability Information (DCI)

DCI specifies information that may not change during the decoding session and may be good for the decoder to know about, e.g. the maximum number of allowed sub-layers. The information in DCI is not necessary for operation of the decoding process. In previous drafts of the VVC specification the DCI was called decoding parameter set (DPS).

The decoding capability information also contains a set of general constraints for the bitstream, that gives the decoder information of what to expect from the bitstream, in terms of coding tools, types of NAL units, etc. In the current version of VVC, the general constraint information could also be signaled in VPS or SPS.

### 6. Picture Header

In the current version of VVC, a coded picture contains a picture header. The picture header contains syntax elements that are common for all slices of the associated picture.

### 7. Slices

A slice divides a picture into independently coded slices, where decoding of one slice in a picture is independent of other slices of the same picture. One purpose of slices is to enable resynchronization in case of data loss.

In the current version of VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. In VVC, a slice is a set of CTUs.

### 8. Tiles

The draft VVC video coding standard includes a tool called tiles that divides a picture into rectangular spatially independent regions. Tiles in the draft VVC coding standard are similar to the tiles used in HEVC. Using tiles, a picture in VVC can be partitioned into rows and columns of CTUs where a tile is an intersection of a row and a column. FIG. 1A shows an example of a tile partitioning using 4 tile rows and 5 tile columns resulting in a total of 20 tiles for the picture.

The tile structure is signaled in the picture parameter set (PPS) by specifying the thicknesses of the rows and the widths of the columns. Individual rows and columns can have different sizes, but the partitioning always span across the entire picture, from left to right and top to bottom respectively.

There is no decoding dependency between tiles of the same picture. This includes intra prediction, context selection for entropy coding and motion vector prediction. One exception is that in-loop filtering dependencies are generally allowed between tiles.

In the rectangular slice mode in VVC, a tile can further be split into multiple slices where each slice consists of a consecutive number of CTU rows inside one tile. FIG. 1B shows an example of a tile partitioning and a rectangular slice partitioning using the tile partitioning in VVC.

### 9. Subpictures

Subpictures are supported in the current version of VVC. Subpictures are defined as a rectangular region of one or more rectangular slices within a picture, such that a subpicture contains one or more slices that collectively cover a rectangular region of a picture. In the current version of the VVC specification, the subpicture location and size are signaled in the SPS. Table 1 shows the subpicture syntax in the SPS in the current version of VVC.

TABLE 1
Simplified Subpicture SPS syntax in
the current version of the VVC draft

| | Descriptor |
|---|---|
| seq_parameter_set_rbsp( ) { | |
| ... | |
| subpic_info_present_flag | u(1) |
| if( subpic_info_present_flag ) { | |
| sps_num_subpics_minus1 | u(8) |
| sps_independent_subpics_flag | |
| for( i = 0; i <= sps_num_subpics_minus1; i++ ) { | |
| subpic_ctu_top_left_x[ i ] | u(v) |
| subpic_ctu_top_left_y[ i ] | u(v) |
| subpic_width_minus1[ i ] | u(v) |
| subpic_height_minus1[ i ] | u(v) |
| ... | |
| } | |
| } | |
| ... | |

Table 2 below contains the corresponding semantics in the VVC draft text:

TABLE 2
subpic_ctu_top_left_x[ i ] specifies horizontal position of top left CTU
of i-th subpicture in unit of CtbSizeY. The length of the syntax element
is Ceil( Log2( ( pic_width_max_in_luma_samples + CtbSizeY −
1) >> CtbLog2SizeY ) ) bits. When not present, the value of
subpic_ctu_top_left_x[ i ] is inferred to be equal to 0.
subpic_ctu_top_left_y[ i ] specifies vertical position of top left CTU of
i-th subpicture in unit of CtbSizeY. The length of the syntax element is
Ceil( Log2( ( pic_height_max_in_luma_samples + CtbSizeY −
1 ) >> CtbLog2SizeY ) ) bits. When not present, the value of
subpic_ctu_top_left_y[ i ] is inferred to be equal to 0.
subpic_width_minus1[ i ] plus 1 specifies the width of the i-th
subpicture in units of CtbSizeY. The length of the syntax element is Ceil(
Log2( ( pic_width_max_in_luma_samples + CtbSizeY − 1 ) >>
CtbLog2SizeY ) ) bits. When not present, the value of
subpic_width_minus1[ i ] is inferred to be equal to ( (
pic_width_max_in_luma_samples + CtbSizeY− 1 ) >> CtbLog2SizeY
) − subpic_ctu_top_left_x[ i ] − 1.
subpic_height_minus1[ i ] plus 1 specifies the height of the i-th
subpicture in units of CtbSizeY. The length of the syntax element is Ceil(
Log2( ( pic_height_max_in_luma_samples + CtbSizeY −
1 ) >> CtbLog2SizeY ) ) bits. When not present, the value of
subpic_height_minus1[ i ] is inferred to be equal to ( (
pic_height_max_in_luma_samples + CtbSizeY− 1 ) >> CtbLog2SizeY
) − subpic_ctu_top_left y[ i ] − 1.

To summarize, a rectangular slice consists of an integer number of CTUs. A subpicture consists of an integer number of CTUs, so a subpicture also consists of an integer number of CTUs.

In a proposal to VVC standardization, JVET-R0135-v4, a method for more efficient signaling of the information shown in Table 1 was proposed. The method consists of signaling the width and height of a subpicture unit that is then used as the granularity for signaling the subpic_ctu_top_left_x[i], subpic_ctu_top_left_y[i], subpic_width_minus1[i], and subpic_height_minus1[i] syntax elements.

### SUMMARY

Certain challenges presently exist. For instance, one problem with the solution of JVET-R0135-v4 is that the method only works when the picture width and height is a multiple of the subpicture unit. This significantly reduces the usefulness of the method because it cannot be applied to many picture sizes and subpicture layouts.

Accordingly, this disclosure introduces one or more scale factors, similar to the subpicture units described in NET-R0135-v4. The position of the top-left corner of the subpicture is also calculated similar to the JVET-R0135-v4 method.

In contrast to the JVET-R0135 method, however, a proposed method disclosed herein first computes an initial width value for the subpicture by multiplying a decoded scale factor value and a decoded subpicture width value. Then, if the initial width value for the subpicture plus the horizontal position of the top-left corner position of the subpicture is larger than the picture width in number of CTUs, the width of the subpicture is set equal to the picture width minus the horizontal position of the top-left corner. Otherwise, the width of the subpicture is set equal to the initial width value for the subpicture. The proposed method may also be used to derive the height of the subpicture using the height of the image and using either the same or another decoded scale factor value. An advantage is that this method can be applied to subpicture layouts for which the picture width or height is not a multiple of the subpicture unit or the scale factor.

According to a first aspect of the present disclosure, there is provided a method for decoding a position for a subpicture, SP, in a picture from a bitstream. The method comprises decoding a CTU size from a first syntax element, S1, in the bitstream. The method comprises obtaining a scale factor value, F, wherein F is larger than 1. The method comprises deriving a scaled position value for the subpicture SP, wherein deriving the scaled position value comprises: i) obtaining a position value based on information in the bitstream and ii) setting the scaled position value equal to the product of the position value and F.

According to a second aspect of the present disclosure, there is provided a computer program comprising instructions which when executed by processing circuitry causes the processing circuitry to perform the method according to the first aspect.

According to a third aspect of the present disclosure, there is provided a carrier containing the computer program according to the second aspect, wherein the carrier is one of an electronic signal, an optical signal, a radio signal, and a computer readable storage medium.

According to a fourth aspect of the present disclosure, there is provided an apparatus, the apparatus being adapted to perform the method according to the first aspect.

### BRIEF DESCRIPTION OF THE DRAWINGS

The accompanying drawings, which are incorporated herein and form part of the specification, illustrate various embodiments.

FIG. 1A shows an example of a tile partitioning using 4 tile rows and 5 tile columns.

FIG. 1B shows an example of a tile partitioning and a rectangular slice partitioning using the tile partitioning in VVC.

FIG. 2 illustrates a system according to an example embodiment.

FIG. 3 is a schematic block diagram of an encoder according to an embodiment.

FIG. 4 is a schematic block diagram of a decoder according to an embodiment.

FIG. 5 is a flowchart illustrating a process according to an embodiment.

FIG. 6 is a block diagram of an apparatus according to an embodiment.

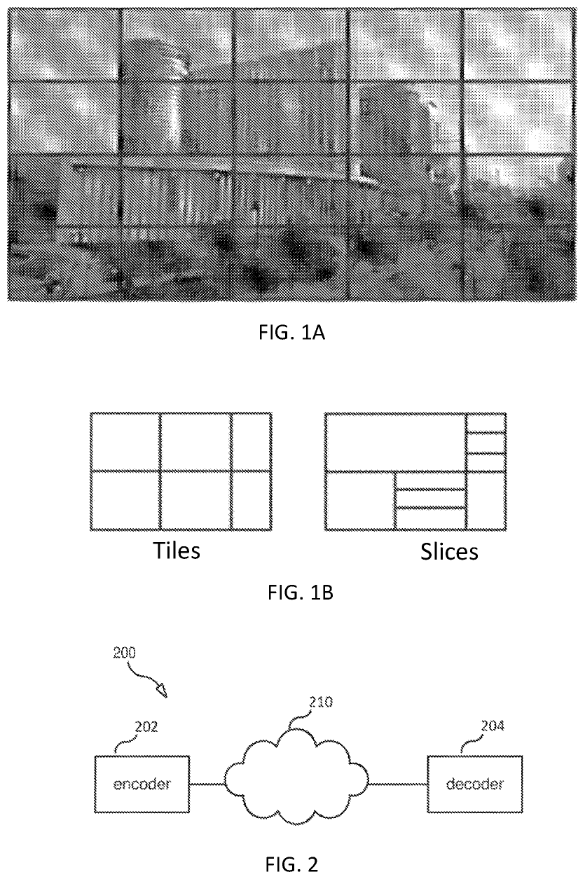

### DETAILED DESCRIPTION

FIG. 2 illustrates a system 200 according to an example embodiment. System 200 includes an encoder 202 in communication with a decoder 204 via a network 210 (e.g., the Internet or other network).

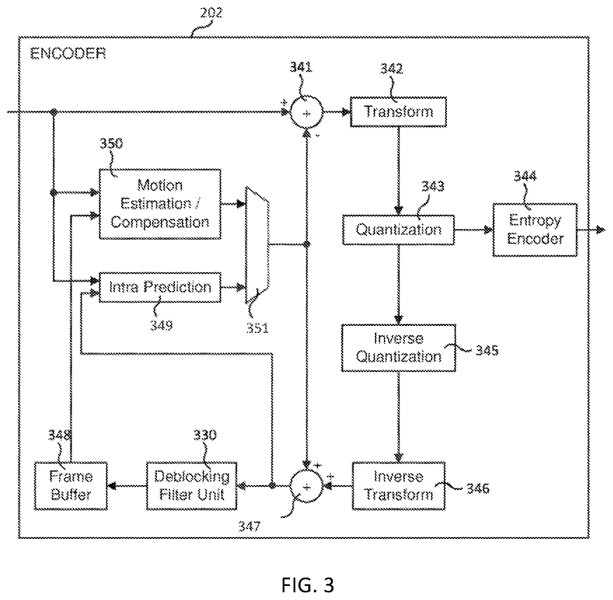

FIG. 3 is a schematic block diagram of encoder 202 for encoding a block of pixel values (hereafter “block”) in a video frame (picture) of a video sequence according to an embodiment. A current block is predicted by performing a motion estimation by a motion estimator 350 from an already provided block in the same frame or in a previous frame. The result of the motion estimation is a motion or displacement vector associated with the reference block, in the case of inter prediction. The motion vector is utilized by a motion compensator 350 for outputting an inter prediction of the block. An intra predictor 349 computes an intra prediction of the current block. The outputs from the motion estimator/compensator 350 and the intra predictor 349 are input in a selector 351 that either selects intra prediction or inter prediction for the current block. The output from the selector 351 is input to an error calculator in the form of an adder 341 that also receives the pixel values of the current block. The adder 341 calculates and outputs a residual error as the difference in pixel values between the block and its prediction. The error is transformed in a transformer 342, such as by a discrete cosine transform, and quantized by a quantizer 343 followed by coding in an encoder 344, such as by entropy encoder. In inter coding, also the estimated motion vector is brought to the encoder 344 for generating the coded representation of the current block. The transformed and quantized residual error for the current block is also provided to an inverse quantizer 345 and inverse transformer 346 to retrieve the original residual error. This error is added by an adder 347 to the block prediction output from the motion compensator 350 or the intra predictor 349 to create a reference block that can be used in the prediction and coding of a next block. This new reference block is first processed by a deblocking filter unit 330 according to the embodiments in order to perform deblocking filtering to combat any blocking artifact. The processed new reference block is then temporarily stored in a frame buffer 348, where it is available to the intra predictor 349 and the motion estimator/compensator 350.

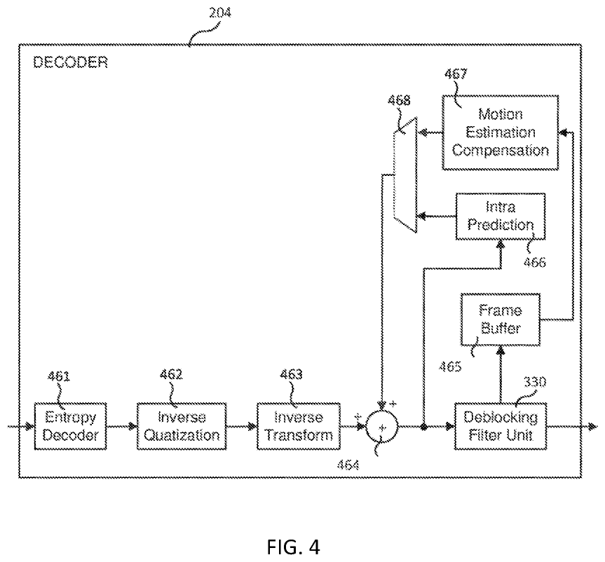

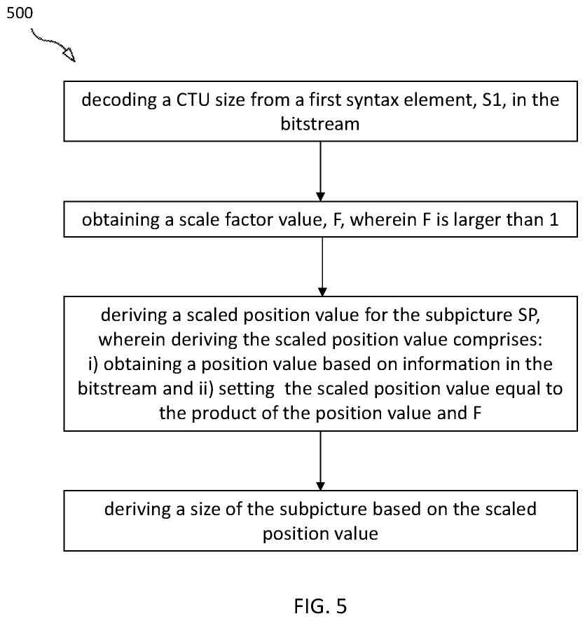

FIG. 4 is a corresponding schematic block diagram of decoder 204 according to some embodiments. The decoder 204 comprises a decoder 461, such as entropy decoder, for decoding an encoded representation of a block to get a set of quantized and transformed residual errors. These residual errors are dequantized in an inverse quantizer 462 and inverse transformed by an inverse transformer 463 to get a set of residual errors. These residual errors are added in an adder 464 to the pixel values of a reference block. The reference block is determined by a motion estimator/compensator 467 or intra predictor 466, depending on whether inter or intra prediction is performed. A selector 468 is thereby interconnected to the adder 464 and the motion estimator/compensator 467 and the intra predictor 466. The resulting decoded block output form the adder 464 is input to a deblocking filter unit 330 according to the embodiments in order to deblocking filter any blocking artifacts. The filtered block is output form the decoder 504 and is furthermore preferably temporarily provided to a frame buffer 465 and can be used as a reference block for a subsequent block to be decoded. The frame buffer 465 is thereby connected to the motion estimator/compensator 467 to make the stored blocks of pixels available to the motion estimator/compensator 467. The output from the adder 464 is preferably also input to the intra predictor 466 to be used as an unfiltered reference block.

### Embodiments

In the description below, various embodiments are described that solve one or more of the above described problems. It is to be understood by a person skilled in the art that two or more embodiments, or parts of embodiments, may be combined to form new solutions which are still covered by this disclosure.

In the embodiments described below, the methods are applied to signaling of the layout or partitioning of pictures into subpictures. In this case, the subpicture may consist of a set of multiple rectangular slices. The rectangular slices may consist of CTUs. The rectangular slices may consist of tiles, that in turn consist of CTUs.

The methods in the embodiments can be used to signal any type of picture partition, such as slices, rectangular slices or tiles or any other segmentations of a picture into segments. That is, any partitioning that can be signaled using a list or set of partitions where each partition is signaled by the spatial position of one corner position such as the top-left corner of the partition and the height and width of the partition.

A CTU may be any type of rectangular picture unit that is smaller or equal to a subpicture. Examples of other picture units than CTUs include coding units (CUs), prediction units and macro-blocks (MBs).

### Alternative 1

In a first embodiment, a picture consists of at least two subpictures, a first subpicture and a second subpicture. For each subpicture, the spatial layout of the subpicture is conveyed in a bitstream to the decoder 204 by information specifying the position of the top-left corner of the subpicture plus the width and height of the subpicture.

The decoder 204, which decodes a coded picture from a bitstream, first decodes the CTU size to use for decoding the picture from one or more syntax elements in the bitstream. The CTU is considered to be square so the CTU size is here one number that represents the length of one side of the luma plane of the CTUs. This is referred to in this disclosure as a one dimensional CTU size.

The decoder further decodes one or more scale factor values from the bitstream. The scale factors are preferably positive integer values larger than one. The same CTU size value and scale factors are used for decoding the spatial locations for all the subpictures of the picture. In this first embodiment, a single scale factor is used.

The decoder 204 decodes the spatial locations for at least two subpictures by, for each subpicture, performing the steps listed below.
Step 1: derive a scaled horizontal position value (H) for the subpicture by decoding one syntax element in the bitstream, thereby obtaining a horizontal position value, and multiplying that horizontal position value by the scale factor to produce the scaled horizontal position value (H).
Step 2: derive a scaled vertical position value (V) of the subpicture by decoding another syntax element in the bitstream, thereby obtaining a vertical position value, and multiplying the vertical position value by the scale factor, thereby producing the scaled vertical position value (V).
Step 3: derive a first width value for the subpicture by decoding a particular syntax element and computing an initial width value by multiplying the obtained first width value by the scale factor. Then a value equal to the initial width value plus the scaled horizontal position value (H) is compared with the picture width. If this value (i.e., the initial width plus the scaled horizontal position) is larger than the picture width, then the width of the subpicture is set equal to the picture width minus the scaled horizontal position (H) such that the rightmost subpicture boundary aligns with the right picture boundary, otherwise the width of the subpicture is set equal to the initial width.

Similar steps are carried out to derive the subpicture height.

First, a first height value for the subpicture is derived by decoding a syntax element. Then an initial height value is computed by multiplying the first height value by the scale factor. Then a value equal to the initial height value plus the scaled vertical position value (V) is compared with the picture height. If this value (i.e., the initial height plus the scaled vertical position (V)) is larger than the picture height, then the height of the subpicture is set equal to the picture height minus the scaled vertical position (V) such that the bottom subpicture boundary aligns with the bottom picture boundary, otherwise, the height of the subpicture is set equal to the initial height.

Accordingly, the following steps may be performed by the decoder 204 for decoding a position and a size for a subpicture SP in a picture from a bitstream.
Decoding a one-dimensional CTU size from a syntax element S1 in the bitstream;
Decoding one or more scale factor values F from one or more syntax elements S3 in the bitstream wherein the scale factor value F is a value larger than 1;
Derive a horizontal position H of the subpicture SP in units of the CTU size by:
   decoding a syntax element S4 in the bitstream, wherein the value of the syntax element S4 represents a horizontal position in number of unit sizes, where the unit size is equal to the scale factor value F multiplied by the CTU size; and
   setting the horizontal position H to the value of the syntax element S4 multiplied by the scale factor value F;
Derive a vertical position V of the subpicture SP in units of the CTU size by:
   decoding a syntax element S5 in the bitstream, wherein the value of the syntax element S5 represents a vertical position in number of unit sizes; and
   setting the vertical position V to the value of the syntax element S5 multiplied by the scale factor value F;
Derive a width of the subpicture SP in units of the CTU size by:
   decoding a syntax element S6 in the bitstream, wherein the value of the syntax element S6 represents a width value in number of unit sizes;
   computing an initial width Iw of the subpicture SP as the value of the syntax element S6 multiplied by the scale factor value F; and
   If the initial width Iw of the subpicture SP plus the horizontal position H is larger than the picture width in units of the CTU size, setting the width of the subpicture SP equal to the picture width in units of the CTU size minus the horizontal position H in units of the CTU size. Otherwise, set the width of the subpicture SP equal to the initial width Iw;
Derive a height of the subpicture SP in units of the CTU size by:
   decoding a syntax element S7 in the bitstream, wherein the value of the syntax element S7 represents a height value in number of unit sizes;
   computing an initial height Ih of the subpicture SP as the value of the syntax element S7 multiplied by the scale factor value F; and
   If the initial height Ih of the subpicture SP plus the vertical position V is larger than the picture height in units of the CTU size, setting the height of the subpicture SP equal to the picture height in units of the CTU size minus the vertical position V in units of the CTU size. Otherwise, set the height of the subpicture SP equal to the initial height Ih.

The subpicture may here consist of an integer number of one or more complete slices such that the subpicture comprises coded data covering a rectangular region of the picture where the region is not the entire picture

In the preferred version of the embodiment, the syntax elements S1, S3, S4, S5, S6 and S7 are decoded from an SPS. In other versions of this embodiment one or more of the syntax elements S1, S3, S4, S5, S6 and S7 may be decoded from a PPS, a picture header, a slice header, or from a decoding capability information (DCI)

Decoding a syntax element to derive a value may comprise a “plus-one” operation such that the value represented in the bitstream is increased by a value of 1 when it is decoded. This is commonly used in VVC and is indicated by a “minus1” suffix used in the name of the syntax elements. In this description, a syntax element may or may not be subject to the +1 operation.

### Alternative 2

In another embodiment, two scale factors instead of one is used. This means that two different scale factors are decoded from the bitstream, one for deriving horizontal values, such as the horizontal positions and the widths of the subpictures, and one for deriving vertical values such as the vertical positions and the heights of the subpictures.

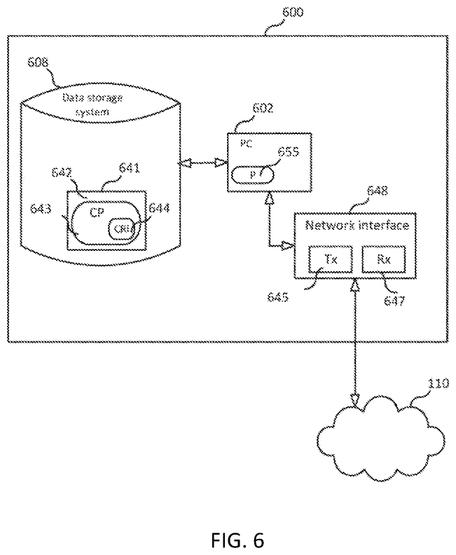

FIG. 6 is a block diagram of an apparatus 600 for implementing decoder 204 and/or encoder 202, according to some embodiments. When apparatus 600 implements a decoder, apparatus 600 may be referred to as a “decoding apparatus 600,” and when apparatus 600 implements an encoder, apparatus 600 may be referred to as an “encoding apparatus 600.” As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); at least one network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding a position and a size for a subpicture (SP) in a picture from a bitstream, the method comprising:
decoding a coding tree unit (CTU) size from a first syntax element (S1) in the bitstream;
obtaining a scale factor value (F) wherein F is larger than 1;
deriving a scaled position value for the subpicture SP, wherein deriving the scaled position value comprises: i) obtaining a position value based on information in the bitstream and ii) setting the scaled position value equal to the product of the position value and F; and
deriving a size of the subpicture based on the scaled position value.

2. The method of claim 1, wherein:
i) the position value is a horizontal position value, h, the scaled position value is a scaled horizontal position value, H=h×F, and the size of the subpicture is a width of the subpicture, Wsp; and/or
ii) the position value is a vertical position value, v, the scaled position value is a scaled vertical position value, V=v×F, and the size of the subpicture is a height of the subpicture, Hsp.

3. The method of claim 2, wherein deriving the size of the subpicture comprises deriving a width of the subpicture (Wsp) based on H, wherein deriving Wsp based on H comprises:
i) obtaining a first width value, w1, based on information in the bitstream;
ii) obtaining an initial width value (Iw) by computing: Iw=(w1)×(F);
iii) comparing (Iw+H) with Pw, where Pw specifies the width of the picture; and
iv) setting Wsp equal to (Pw−H) if (Iw+H>Pw), otherwise setting Wsp equal to Iw.

4. The method of claim 2, wherein deriving the size of the subpicture comprises deriving a height of the subpicture (Hsp) based on V, wherein deriving Hsp based on V comprises:
i) obtaining a first height value (h1) based on information in the bitstream;
ii) obtaining an initial height value (Ih) by computing: Ih=(h1)×(F);
iii) comparing (Ih+V) with Ph, where Ph specifies the height of the picture; and
iv) setting Hsp equal to (Ph−V) if (Ih+V>Ph), otherwise setting Hsp equal to Ih.

5. The method of claim 1, wherein obtaining the horizontal position value (h) based on information in the bitstream comprises:
decoding a syntax element S4 in the bitstream to obtain h, wherein the value of the syntax element S4 represents a horizontal position in number of unit sizes, where the unit size is equal to the scale factor value F multiplied by the CTU size.

6. The method of claim 1, wherein obtaining the vertical position value (v) based on information in the bitstream comprises:
decoding a syntax element S5 in the bitstream to obtain v, wherein the value of the syntax element S5 represents a vertical position in number of unit sizes.

7. The method of claim 1, wherein two separate scale factor values F1 and F2 having different values are obtained, wherein
one scale factor value F1 is used as scale factor value F for deriving at least one of the horizontal position of the subpicture and the width of the subpicture, and
the other scale factor value F2 is used as scale factor value F for deriving at least one of the vertical position of the subpicture and the height of the subpicture.

8. The method of claim 1, wherein one or more of the syntax elements S1, S4 and S5 are decoded from a sequence parameter set.

9. The method of claim 1, wherein one or more of the syntax elements S1, S4 and S5 may be decoded from a picture parameter set a picture header, a slice header, or from a decoding capability information.

10. A non-transitory computer readable storage medium storing a computer program comprising instructions which when executed by processing circuitry of an apparatus causes the apparatus to perform the method of claim 1.

11-12. (canceled)

13. An apparatus, the apparatus comprising:
processing circuitry; and
a memory, said memory containing instructions executable by said processing circuitry, wherein said apparatus is operative to perform a method comprising
decoding a coding tree unit (CTU) size from a first syntax element (S1) in the bitstream;
obtaining a scale factor value (F) wherein F is larger than 1;
deriving a scaled position value for the subpicture SP, wherein deriving the scaled position value comprises: i) obtaining a position value based on information in the bitstream and ii) setting the scaled position value equal to the product of the position value and F; and
deriving a size of the subpicture based on the scaled position value.

14. The apparatus of claim 13, wherein:
i) the position value is a horizontal position value, h, the scaled position value is a scaled horizontal position value, H=h×F, and the size of the subpicture is a width of the subpicture, Wsp; and/or
ii) the position value is a vertical position value, v, the scaled position value is a scaled vertical position value, V=v×F, and the size of the subpicture is a height of the subpicture, Hsp.

15. The apparatus of claim 14, wherein deriving the size of the subpicture comprises deriving a width of the subpicture (Wsp) based on H, wherein deriving Wsp based on H comprises:
i) obtaining a first width value, w1, based on information in the bitstream;
ii) obtaining an initial width value (Iw) by computing: Iw=(w1)×(F);
iii) comparing (Iw+H) with Pw, where Pw specifies the width of the picture; and
iv) setting Wsp equal to (Pw−H) if (Iw+H>Pw), otherwise setting Wsp equal to Iw.

16. The apparatus of claim 14, wherein deriving the size of the subpicture comprises deriving a height of the subpicture (Hsp) based on V, wherein deriving Hsp based on V comprises:
i) obtaining a first height value (h1) based on information in the bitstream;
ii) obtaining an initial height value (Ih) by computing: Ih=(h1)×(F);
iii) comparing (Ih+V) with Ph, where Ph specifies the height of the picture; and
iv) setting Hsp equal to (Ph−V) if (Ih+V>Ph), otherwise setting Hsp equal to Ih.

17. The apparatus of claim 13, wherein obtaining the horizontal position value (h) based on information in the bitstream comprises:
decoding a syntax element S4 in the bitstream to obtain h, wherein the value of the syntax element S4 represents a horizontal position in number of unit sizes, where the unit size is equal to the scale factor value F multiplied by the CTU size.

18. The apparatus of claim 13, wherein obtaining the vertical position value (v) based on information in the bitstream comprises:
decoding a syntax element S5 in the bitstream to obtain v, wherein the value of the syntax element S5 represents a vertical position in number of unit sizes.

19. The apparatus of claim 13, wherein two separate scale factor values F1 and F2 having different values are obtained, wherein
one scale factor value F1 is used as scale factor value F for deriving at least one of the horizontal position of the subpicture and the width of the subpicture, and
the other scale factor value F2 is used as scale factor value F for deriving at least one of the vertical position of the subpicture and the height of the subpicture.

20. The apparatus of claim 13, wherein one or more of the syntax elements S1, S4 and S5 are decoded from a sequence parameter set.

21. The apparatus of claim 13, wherein one or more of the syntax elements S1, S4 and S5 may be decoded from a picture parameter set, a picture header, a slice header, or from a decoding capability information.
